(19) United States
(12) Patent Application Publication
(10) Pub. No.: US 2026/0261525 A1
(43) Pub. Date: Sep. 3, 2026

(54) INTELLIGENT DISTRIBUTED MICROSERVICES INFRASTRUCTURE FRAMEWORK

(71) Applicant: Palo Alto Networks, Inc., Santa Clara, CA (US)

(72) Inventor: Walter Boxuan Guo, San Ramon, CA (US)

(21) Appl. No.: 19/067,425

(22) Filed: Feb. 28, 2025

(51) Int. Cl. H04L 47/78; H04L 41/16; H04L 41/50

(52) U.S. Cl. CPC H04L 47/788; H04L 41/16; H04L 41/5032

(57) ABSTRACT

A framework has been created that intelligently predicts a state of cloud infrastructure that can be used to inform scaling. The framework utilizes a forecast model that predicts resource demand and machine learning to learn traffic profiles for repeating time segments (e.g., days and times) based on combinations of request traffic features. The individual signals of forecasted demand, observed traffic profile, expected traffic profile for the given time segment, and observed demand are combined as input to a deep learning model that has been trained to predict the state of the cloud infrastructure based on the intelligence provided by the combination of signals. The predicted cloud infrastructure state can then be mapped to a command(s) or action(s) passed to an autoscaler for rapid adaptation to demand.

### BACKGROUND

The disclosure generally relates to machine learning and scaling resources of distributed microservices based on predictions from machine learning components (e.g., CPC subclass G06F 2209/50).

The adoption of cloud computing to deliver applications or services (e.g., Software-as-a-Service (SaaS), Infrastructure-as-a-Service (IaaS), Firewall-as-a-Service (FWaaS)) has had an impact on the evolution of distributed computing. Distributed system technologies rely on different paradigms for coordination among the individual compute entities/nodes, such as mobile agents, client/server architecture, service oriented architecture (SOA), and microservices architecture. Cloud delivered applications/services leverage the microservices architecture.

With the microservices architecture, an application is built with smaller independent services (i.e., microservices). Microservices are considered independent because they use a lightweight communication paradigm instead of a centralized communication paradigm (e.g., a centralized message bus). The lightweight communication paradigm can use application programming interface (API) calls, such as calls defined by representational state transfer (REST) APIs, or messaging protocols. Dividing functionality into microservices also facilitates reusability of microservices. Thus, a microservice or collection of microservices can be used to support multiple applications delivered with cloud computing.

### BRIEF DESCRIPTION OF THE DRAWINGS

Embodiments of the disclosure may be better understood by referencing the accompanying drawings.

FIG. 1 is a diagram of a system training components for a framework to predict cloud state infrastructure and to rapidly and intelligently adapt distributed microservices to the variations in demand.

FIG. 2 is a conceptual diagram of use of the deployed framework that predicts cloud state infrastructure and rapidly and intelligently adapts distributed microservices.

FIG. 3 is a flowchart of example operations for creating a framework of components to intelligently predict state of a cloud infrastructure based on a collection of features of request traffic of microservices.

FIG. 4 is a flowchart of example operations for generating cloud infrastructure states based on observed and forecasted traffic profiles and forecasted and observed resource demands.

FIG. 5 depicts an example computer system with an intelligent microservices manager.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Introduction

Distributed microservices architecture facilitates multiple benefits for application development and application/service delivery, including scalability. While resources for microservices can be scaled, decisions for when to scale and magnitude of scaling (either increasing or decreasing scale) must be made. Without intelligence, these decisions can lead to over-provisioning, which costs money. Or these decisions without intelligence can lead to under-provisioning, which impacts availability and performance. Autoscaling allows for some informed horizontal scaling of resources to adjust to fluctuating workloads. But a horizontal autoscaler is usually inflexible and scales based on limited information of current workload and resource utilization.

While a cloud infrastructure shares similarities with other infrastructure (e.g., energy infrastructure), smart energy grids can predict load/demand on an energy grid with few features (e.g., number of customers, time of day, and weather) for a single resource, energy. The demand on cloud infrastructure that supports distributed microservices that support cloud applications/services involves multiple resources (e.g., compute instances, storage, processor units, network bandwidth, etc.). In addition, the demand on cloud infrastructure fluctuates in relation to different combinations of different features of the communications to microservices ("request traffic"). A few examples of request traffic features include traffic volume, types of requests, and sources of requests.

### Overview

A framework has been created that intelligently predicts a state of cloud infrastructure that can be used to inform scaling. The framework utilizes a forecast model that predicts resource demand and machine learning to learn traffic profiles for repeating time segments (e.g., days and times) based on combinations of request traffic features. The individual signals of forecasted demand, observed traffic profile, expected traffic profile for the given time segment, and observed demand are combined as input to a deep learning model that has been trained to predict the state of the cloud infrastructure based on the intelligence provided by the combination of signals. The predicted cloud infrastructure state can then be mapped to a command(s) or action(s) passed to an autoscaler for rapid adaptation to demand.

### Example Illustrations

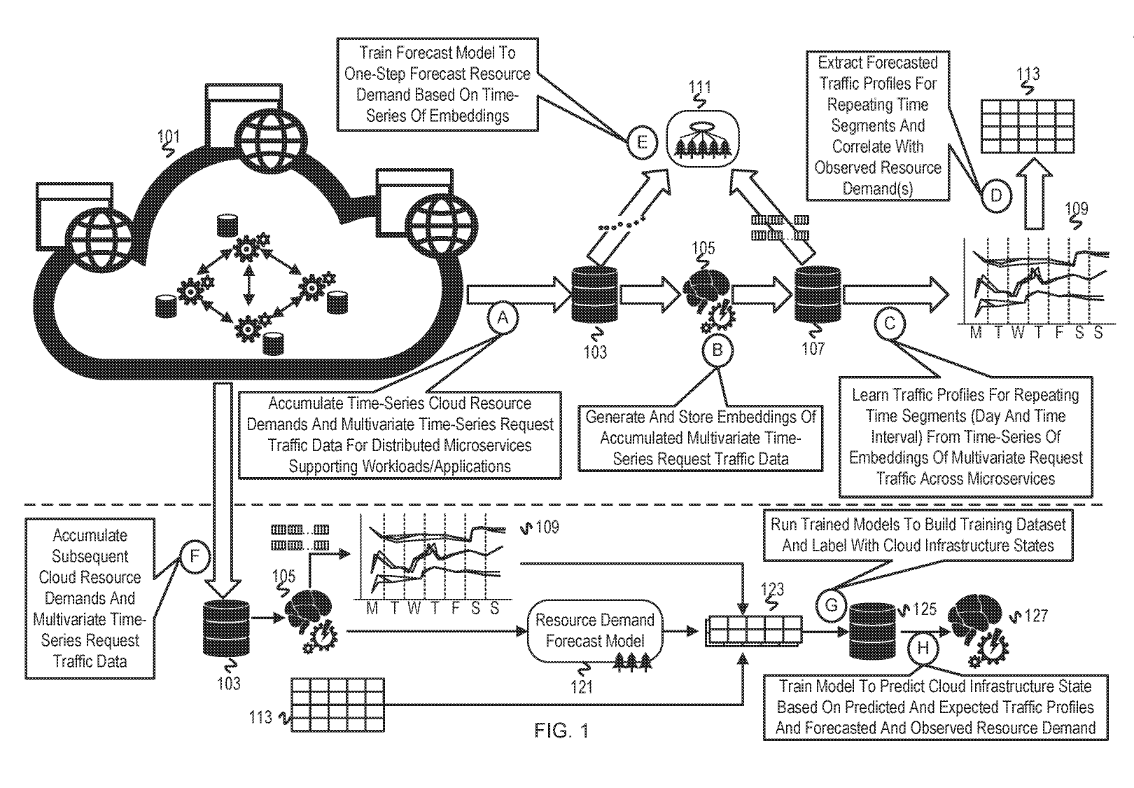

FIG. 1 is a diagram of a system training components for a framework to predict cloud state infrastructure and to rapidly and intelligently adapt distributed microservices to the variations in demand. Creation of the framework uses time-series request traffic data and time-series resource demand data that has been accumulated for distributed microservices of a cloud infrastructure 101. FIG. 1 depicts the cloud infrastructure 101 supporting distributed microservices and multiple applications provided with the cloud infrastructure 101 with the distributed microservices. A cloud- based or web application can have multiple workflows, each of which is supported by different combinations of microservices. Typical examples of different workflows for a web application include a login, shopping cart, and inventory. The request traffic data may be collected at the granularity of workflows, but example illustrations will refer to applications to avoid obfuscating the technology.

FIG. 1 is annotated with a series of letters A - H representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the system accumulates into a repository 103 (e.g., a data lake, data warehouse, database, etc.) time-series cloud resource demands and multivariate time-series request traffic data for distributed microservices supporting applications/workloads of the cloud infrastructure 101. If a tenant of a cloud service corresponding to the cloud infrastructure 101 offers multiple applications that rely on overlapping microservices, request traffic can be accumulated without delineating the applications if a tenant prefers to scale resources across all services/applications it offers. The example illustrations herein presume delineation by application, in which case the resource demand and cloud infrastructure state predictions will be with respect to an application instead of across applications. Similarly, the example illustrations presume request traffic data delineated by application instead of tenant or application group/class.

At stage B, the system generates and stores embeddings of accumulated multivariate time-series request traffic data. The system uses an embedding model 105 to generate the embeddings which aggregate the multiple features of request traffic data into a representative feature vector. Raw values for features will be extracted from each sample/observation in the time-series request traffic data. The features of the request traffic data are features of the aggregate of request traffic across distributed microservices and not features of individual requests. Examples of the request traffic features include request volume across microservices, proportion of request traffic for each type of request, and number of different sources of request traffic. The system stores the embeddings into a repository 107.

At stage C, the system learns traffic profiles for repeating time segments from the time-series of embeddings of multivariate request traffic across microservices. A "traffic profile" refers to request traffic behavior as represented by embeddings over time. The behavior learned is not specific, such as high traffic volume, because it is behavior in terms of multiple different signals, i.e., the different features. Thus, the behavior is a complex multi-variate behavior captured into a vector with the embeddings. The system uses repeating time segments that inform design of the forecast model that will be described in stage E. The repeating time segment is chosen based on expected recurring patterns. For instance, the repeating time segments can be 10-minute intervals of each day. This is chosen based on an expectation that behavior corresponding to the distributed microservices will have seasonality (e.g., similar patterns every Monday from 10:00 AM to 10:10 am) but the seasonality is not guaranteed as anomalous behavior can occur and behavior can shift. Granularity of the time intervals is chosen and can be adjusted to be sensitive to changes in patterns while avoiding redundant information at an expensive high resolution, such as every 5 seconds with observations at 1 second or less. Unsupervised machine learning algorithms can be used to learn behavioral similarities of time-series subsequences within the accumulated time-series embeddings. The system uses the time-series embeddings from the repository 107 as a training dataset and iteratively retrieves embeddings of repeating time segments ("subsequences") to train a model 109 to learn the traffic profiles according to an algorithm, such as a clustering algorithm or k-nearest neighbor algorithm. As an example, the accumulated time-series data can be over multiple months and the subsequences be 10-minute intervals consisting of 10 observations. The model 109 would group behaviors as represented by the embeddings that are similar for each repeating time segment. Each grouping can be labeled automatically to distinguish groups or manually labeled to provide meaningful labels.

At stage D, the system creates a table 113 of traffic profiles correlated with resource demand based on time. The system extracts expected/forecasted traffic profiles for repeating time segments from the model 109. A function call to the model or as defined in a library for the model can be made that specifies a time subsequence and returns one or more groupings. The system accesses the repository 103 to obtain demand observations within the same time subsequence and correlates the demand observation, such as number of compute instances, with a traffic profile. With the table 113, the system can later retrieve a traffic profile and corresponding demand expected for a specified time.

At stage E, the system trains a model 111 to one-step forecast resource demand based on the time-series of embeddings that were stored into the repository 107. For the training dataset, the system also obtains the resource demand observations from the repository 103 correlated with the timestamps of the time-series embeddings retrieved from the repository 107. The system can use a random forest algorithm to build and train the model 111 into a resource demand forecast model 121. For consistency with the training of the model 109, the system trains the model 111 according to the repeating time segments. If the traffic profile model 109 was trained on 10-minute intervals of observations at 1 minute granularity, then the model 111 would be trained to forecast demand 10 minutes into the future from a time t, based on a current observation at time t and the lagging embeddings at times t-1, t-2, t-3...t-9. Stages C and E can occur in parallel or in a different order than described.

At stage F, the system accumulates a subsequent time-series dataset for the cloud infrastructure 101. Again, the system accumulates resource demands over time and multivariate request traffic data over time at a predefined resolution or granularity that is the same as before. This accumulated time-series dataset is added to the repository 103 and will be used to create a training dataset to train a deep learning model 127 to predict a cloud infrastructure state based on outputs from the resource demand forecast model 121, the traffic profile - demand correlation table 113, and the traffic profile model 109.

At stage G, the system runs the trained models to build the training dataset for the deep learning model 127. The system uses the embedding model 105 to generate embeddings of the request traffic data features in the subsequently accumulated request traffic data. The system then uses the traffic profile model 109 to obtain traffic profiles for time subsequences corresponding to the repeating time segments. For instance, the system determines a cluster membership or nearest neighbor for each time-series of embeddings. For each of the time-series subsequences of embeddings corresponding to repeating time segments, the system reads out both a resource demand correlated to the traffic profile to which the subsequence of embeddings was classified ("observed traffic profile") and a traffic profile expected based on the time of the time-series subsequence of embeddings ("expected traffic profile"). For instance, a subsequence of embeddings 15:00:00 - 15:10:00 on a Tuesday is classified as traffic profile "P2." But the table 113 indicates that the traffic profile "P3" is expected for the repeating time segment 15:00:00 - 15:10:00 on a Tuesday. In addition, the system runs the resource demand forecast model 121 on each subsequence of embeddings to obtain a forecasted demand. The system forms feature matrices 123 from combinations of forecasted demand, observed demand, expected traffic profile, and observed traffic profile. The feature matrices 123 are labeled with state labels that describe state of the cloud infrastructure at a time of a feature matrix. In advance, mappings are created between state labels and actions/command for an autoscaler. Example cloud infrastructure state labels include "replicas overprovisioned," "replicas underprovisioned," "replica count meets desired replicas," "virtual machines underprovisioned," "virtual machines overprovisioned," "containers underprovisioned," "containers underprovisioned," "memory underprovisioned," "memory overprovisioned," and "resources provisioned adequately."

At stage H, the system trains the deep learning model 127 on the labeled feature matrices 123. With the training dataset, the deep learning model 127 learns to predict a cloud infrastructure state based on an expected traffic profile, an observed traffic profile, a forecasted demand, and an observed current demand. The deep learning model 127 will learn patterns among the complex multivariate relationships occurring between changes in request traffic behavior as represented by traffic profiles, differences between expected and observed behaviors as represented by traffic profiles, and the gap between currently observed demand and forecasted demand. After completion of training, a framework can be deployed with the resource demand forecasting model 121, the traffic profile model 109, and traffic profile-demand correlations table 113, and the trained deep learning model 127.

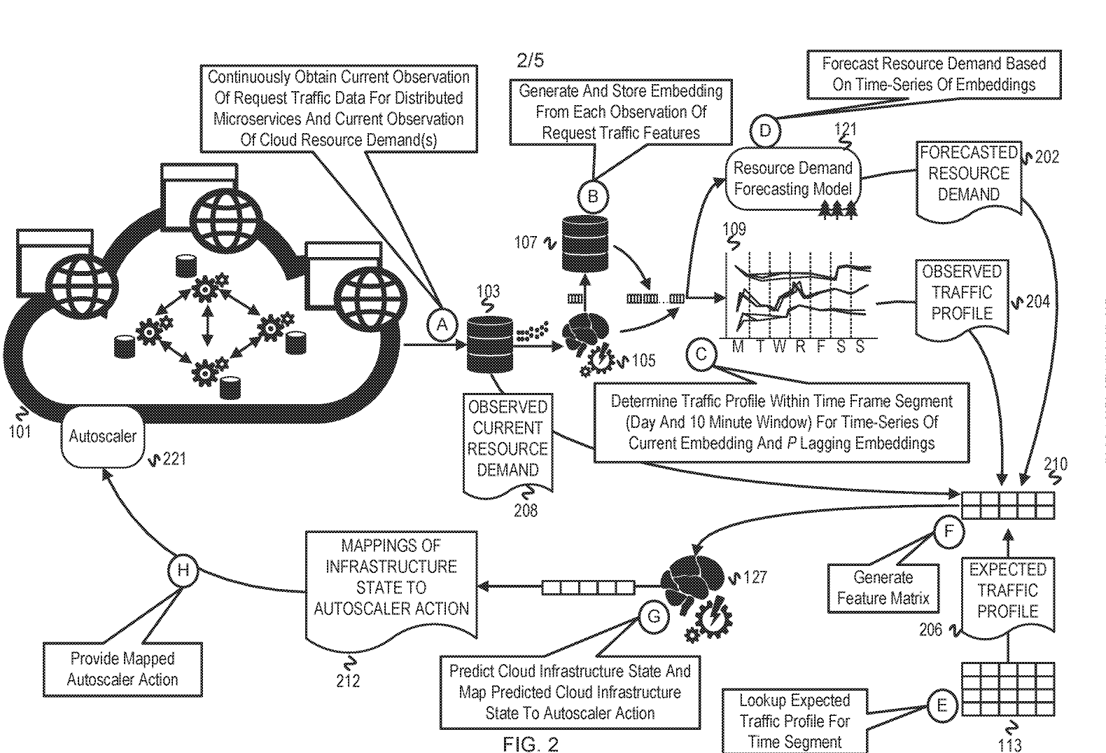

FIG. 2 is a conceptual diagram of use of the deployed framework that predicts cloud state infrastructure and rapidly and intelligently adapts distributed microservices. FIG. 2 includes the framework components introduced and trained in FIG. 1: the embedding model 105, the traffic profiling model 109, the resource demand forecast model 121, the traffic profile-demand correlations table 113, and the trained deep learning model 127. The framework can be considered as constituting a pipeline that takes as input a current observation andp lagging observations (i.e., request traffic features) and outputs a predicted cloud infrastructure state from the trained deep learning model 127.

FIG. 2 is annotated with a series of letters A - H representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the framework for intelligent, adaptive microservices continuously obtains current observations of request traffic data for distributed microservices of the cloud infrastructure 101. In addition, the framework continuously obtains currently observed demand of one or more resources of the cloud infrastructure 101. The obtained observations are stored into the repository 103. Obtaining the request traffic data observations can include querying a traffic monitoring service as the traffic features to be extracted are aggregate request features or the framework can extract and update intermediate values until the end of an observation period. The framework records timestamps with the observations if time is not already incorporated into the observation itself.

At stage B, the framework generates embeddings from the observations with the embedding model 105 and stores the embeddings with corresponding timestamps into the repository 107. The framework invokes the embedding model 105 on each observation of request traffic data.

At stage C, the framework determines a traffic profile for the repeating time segment that includes the current observation and p lagging observations. Continuing with the 10-minute interval example, the framework invokes the traffic profiling model 109 on a subsequence of embeddings for the time window 15:00:00 - 15:10:00 when the current observation for 15:10:00 is obtained and includes the observations for the preceding 9 minutes. The traffic profiling model 109 outputs an observed traffic profile 204.

At stage D, the framework invokes the resource demand forecast model 121 on the subsequence of embeddings corresponding to the current observation. As with the traffic profiling, the forecast of resource demand uses a same size of observations - the embeddings for the current observation and the p lagging observations. With the time- series of embeddings, the resource demand forecast model 121 generates a forecasted resource demand 202. Thus, a resource demand has been forecasted for the time-series of embeddings with the observed traffic profile 204.

At stage E, the framework looks up or retrieves an expected traffic profile 206 from the table 113 based on the time of the current observation. The framework will query the table with the time window and the day, for example, to obtain the expected traffic profile 206.

At stage F, the framework generates a feature matrix 210. The framework retrieves from the repository 103 observed current resource demand 208. The observed current resource demand 208 corresponds to the time of the current observation. The framework combines the observed current resource demand 208 with the forecasted resource demand 202, the observed traffic profile 204, and the expected traffic profile 206 to form the feature matrix 210.

At stage G, the framework predicts a cloud infrastructure state and adapts the cloud infrastructure 101 to the predicted state. The framework invokes the trained deep learning model 127 on the feature matrix 210 to predict a cloud infrastructure state. The framework then maps the predicted state to an autoscaler action(s) with mappings 212. As mentioned previously, the states used to train the deep learning model 127 are based on the mappings created in advance.

At stage H, the framework provides the mapped autoscaler action(s) to an autoscaler 221. A provider of the cloud infrastructure 101 will expose an API of the autoscaler 221 to allow tenants to invoke the autoscaler 221. The framework will form an API call to the autoscaler 221 based on the mapped action(s).

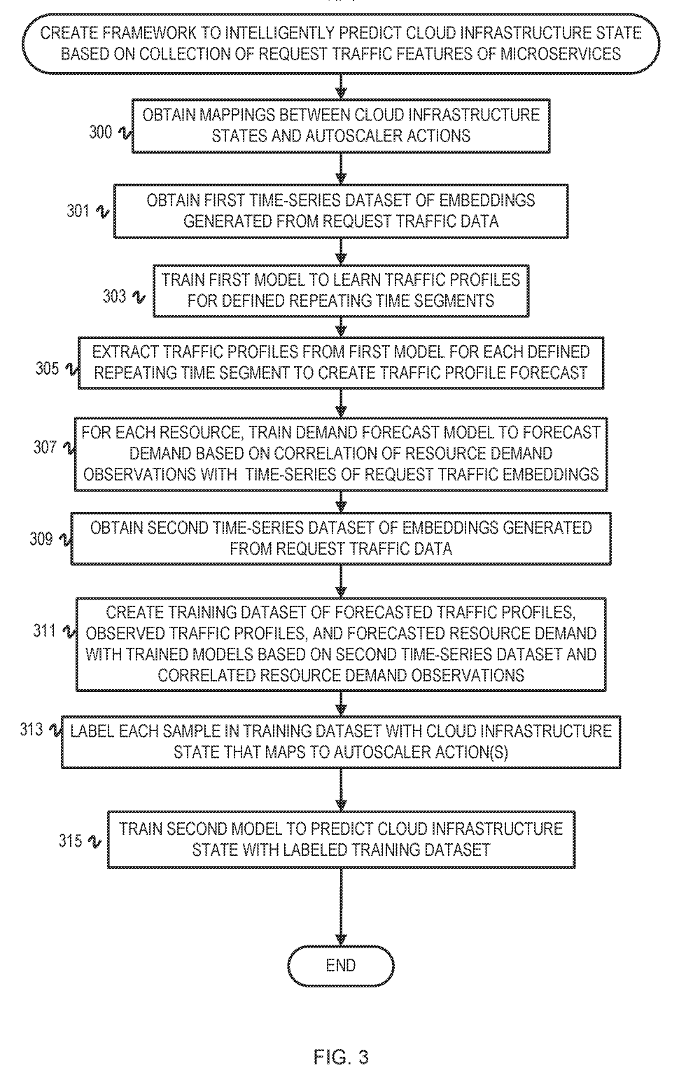

FIG. 3 is a flowchart of example operations for creating a framework of components to intelligently predict state of a cloud infrastructure based on a collection of features of request traffic of microservices. Intelligent prediction of cloud infrastructure state facilitates adaptation of the cloud infrastructure for optimal or near-optimal provisioning of resources. This minimizes or avoids waste and avoids impacts on application/service performance. To be intelligent, the prediction relies on learning complex relationships across time of different request traffic features. This involves the use of multiple machine-learning components to learn similar temporal behaviors of request traffic as represented by time-series embeddings of multiple features, to forecast demand based on time-series of embeddings representing multivariate traffic behavior, and to learn to predict state of cloud infrastructure based on current observed demand, forecasted demand, expected traffic behavior (i.e., the traffic profile), and the observed traffic profile. The example operations of FIG. 3 are described with reference to a system, which is a system that builds the framework.

At block 300, the system obtains mappings between cloud infrastructure states and autoscaler actions. The values mapped can vary by preference or design, but below are examples of mappings that are human readable.
E-HP-Spike-L4 --> Scale Primary Sample Process Workflow
FE : Front End
HP : High Priority
Spike : Traffic Nature
L4 : Severity Level 4

At block 301, the system obtains a first time-series dataset of embeddings generated from request traffic data. It is presumed for these example operations that a historical time-series dataset for microservices of a set of one or more applications is available for creating the framework. The request traffic data includes data for metrics that a cloud service provider would maintain for each tenant and are accessible via API calls defined by the cloud service provider. In some embodiments, raw traffic or captured packets can be analyzed and the request traffic features calculated therefrom.

At block 303, the system trains a first model to learn traffic profiles for defined repeating time segments. The first model is trained to learn groups of similar embeddings that represent a collection of different signals for behavior (i.e., the request traffic features). The first time-series dataset of embeddings is segmented by repeating time segment to train the first model to learn by repeating time segments. Previously examples referred to 10-minute intervals that repeat each day. The system retrieves each subsequence of embeddings aligned to the repeating time segment boundaries (e.g., every ten minutes starting at the top of the hour) as a training sample for the first model.

At block 305, the system extracts traffic profiles from the first model for each defined repeating time segment to create a traffic profile forecast. After the first model has been trained to learn or discover traffic profiles, the system extracts the traffic profiles by repeating time segment. For instance, the system invokes a defined-function call that queries the first model for a traffic profile discovered for the repeating time segments Mondays from 10:00:00 - 10:10:00. Later, the traffic profile forecast can be queried with parameters defining a repeating time segment to obtain an expected/forecasted traffic profile for that repeating time segment.

At block 307, the system trains a demand forecast model for each resource of the cloud infrastructure to forecast demand for that resource. For each resource, a forecast model is trained based on time-based correlations of demand observations for the resource with the request traffic embeddings. The previous examples referred to a single demand for a single resource, compute instance, for ease of explanation. However, different resources may be scaled and demand for those different resources correlated with the request traffic embeddings. Thus, an embodiment can have multiple trained forecast models for the multiple resources that could be scaled. Accordingly, the embodiments may have multiple cloud state infrastructure prediction models: cloud infrastructure prediction model for each workflow and cloud state infrastructure prediction model for each application.

At block 309, the system obtains a second time-series dataset of embeddings generated from request traffic data. As previously mentioned, the second time-series dataset is for creating training data for training a second model to predict cloud infrastructure state. The second time-series dataset of embeddings are based on data of request traffic occurring more recently than the request traffic corresponding to the first time-series dataset. A collected dataset of historical time-series data of both resource demand observations and request traffic data over 6 months, for example, can be separated into data of the first 4 months and data of the last 2 months. The first 4 months of data would be the source of the first time-series dataset while the more recent 2 months would be the source of the second time-series dataset. Implementations can vary the proportions of the training datasets.

At block 311, the system creates a training dataset to train the second model to predict cloud infrastructure state. To create the training dataset for the second model, the system uses the first model trained to profile traffic and the traffic profile forecasts. The system uses traffic profile forecasts to determine expected traffic profiles for the second time-series dataset based on repeating time segments. The system uses the trained first model to generate observed traffic profiles based on subsequences of embeddings of the second time-series training dataset, with the subsequence aligned to the repeating time segments. The system also correlates the subsequences of embeddings to demand observations for each resource that impacts performance of the microservices and includes the correlated resource demand observations into the training dataset for the second model.

At block 313, each sample in the created training dataset is labeled with a cloud infrastructure state. The cloud infrastructure states are from the previously obtained mappings to corresponding autoscaler actions. A cloud infrastructure state describes state of cloud infrastructure in terms of resource provisioning in light of a currently observed traffic profile and currently observed demand and a forecasted demand based on an observed traffic profile. Assume a sample st. The sample st includes a traffic profile observed based on the embeddings at times t-p ...t-2, t-1, and t, withp being the lagging variable, and a resource demand forecasted based on the same subsequence of embeddings. The sample st also includes a traffic profile forecasted/expected for the repeating time segment corresponding to time t. The sample st also includes the resource demand observed at time t. This sample st would be labeled with a cloud infrastructure state that would map to an autoscaler action to adapt the currently observed state of the cloud infrastructure as represented by the observed traffic profile and the observed current demand to a state sufficient for the forecasted demand in light of the expected traffic profile, which is another signal of information for state prediction.

At block 315, the system trains the second model to predict cloud infrastructure state with the labeled training dataset. The system would invoke a training function for the type of model being used.

While FIG. 3 presents example operations for an initial training, implementations will re-train the framework components. The framework components can be retrained with additional, more recent data to capture changes that can occur in behavior. In addition, longer time windows of data, for example a year, may allow the framework components to learn seasonal patterns at a larger temporal granularity than days. For instance, the repeating time segments may be the time intervals on specified days in specified months.

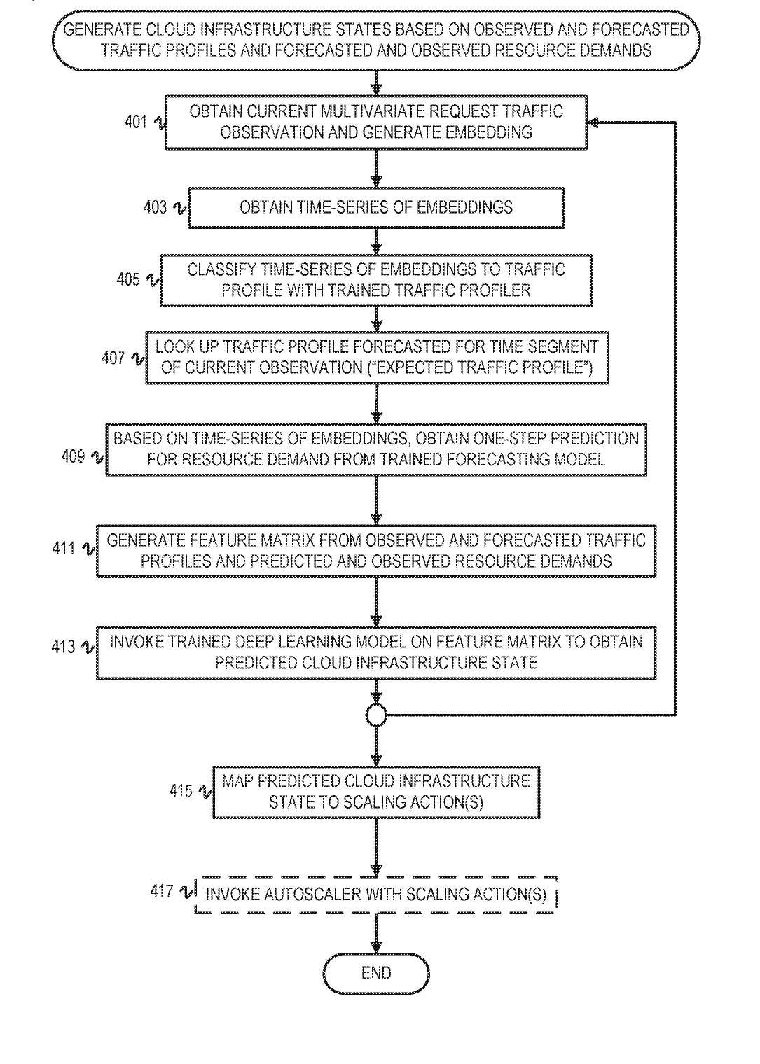

FIG. 4 is a flowchart of example operations for generating cloud infrastructure states based on observed and forecasted traffic profiles and forecasted and observed resource demands. Use of the disclosed framework will likely involve ongoing predictions to facilitate real-time or near real-time reaction to departures from forecasted behavior. The forecasting and traffic profiling will be ongoing to feed the model that predicts cloud infrastructure state ("cloud infrastructure state predictor") for ongoing cloud infrastructure state predictions. This can be used to present visualizations to allow administrators to view performance by tracking the resource demands with the forecasted resource demands. When deployed, the framework can be considered a manager of the distributed microservices for which the framework components were trained. This "intelligent microservices manager" would include program code to obtain observations and orchestrate the invocations of the trained components of the framework. Accordingly, the example operations of FIG. 4 are described with reference to an intelligent microservices manager.

At block 401, the intelligent microservices manager obtains a current multivariate request traffic observation and generates an embedding. As previously mentioned, obtaining a request traffic data observation involves obtaining values of aggregate traffic features and may involve collecting values of individual traffic features. For aggregate request traffic features, the intelligent microservices manager may query a cloud service API of the cloud infrastructure. For the individual traffic features, the intelligent microservices manager may process raw data from captured protocol data units (PDUs), such as packets or application layer messages. Using request type as an example feature, the intelligent microservices manager may track which request types are observed in a time window with an array that represents the different request types by position in the array. Each entry in the array can either be a flag indicating whether any requests of the corresponding type have been observed or a count of the request types that have been observed. The array or vector would reflect the request type feature for each PDU or across PDUs and be used as an aggregate traffic feature. The intelligent microservices manager would aggregate the different feature values into a feature matrix and then invoke an embedding model to generate an embedding of the extracted feature values.

At block 403, the intelligent microservices manager obtains a time-series of embeddings. The intelligence microservices manager retrieves embeddings that correspond to p lagging request traffic data observations with respect to the current request traffic observation. These form the time-series of embeddings that will be the basis for the observed traffic profile and the forecasted resource demand.

At block 405, the intelligent microservices manager classifies the time-series of embeddings to one of the previously discovered traffic profiles with a trained traffic profiler. As explained earlier, the trained traffic profiler is a machine learning model that has been trained to learn or discover subsequences of embeddings for repeating time segments that have similar behavior as represented by the embeddings. The traffic profile indicated by the trained traffic profiler is the "observed traffic profile" since it is based on similarity of the time-series of embeddings corresponding to the current observation representing current state of the traffic.

At block 407, the intelligent microservices manager accesses the forecast of traffic profiles to look up the traffic profile forecasted for the time segment of the current observation. Assuming the current observation corresponds to 15:10:00 on Thursday in May, the forecasted traffic profile will be the traffic profile expected on a Thursday in May for the 15:00:00 - 15:10:00 time interval.

At block 409, the intelligent microservices manager obtains a one-step prediction for resource demand from a model that has been trained to forecast resource demand based on subsequences of embeddings. The intelligence microservices manager invokes the trained forecast model on the time-series of embeddings. This trained forecast model can be based on a suitable machine-learning model for time-series based predictions (e.g., neural network, a random forest, a support vector machine, etc.). Embodiments can train a model for multi-step prediction assuming availability of a larger amount of historical data and acceptance of potential prediction degradation proportional to the increase in the forecast horizon. In addition, embodiments can train a model to forecast based on a time-series of traffic profiles instead of request traffic data embeddings.

At block 411, the intelligent microservices manager generates a feature matrix from the observed and forecasted traffic profiles and the predicted and observed resource demands. The intelligent microservices manager organizes the obtained traffic profiles and resource demands into a feature vector or feature matrix in accordance with the arrangement of inputs during training of the cloud infrastructure state predictor.

At block 413, the intelligent microservices manager invokes a trained deep learning model on the feature matrix to obtain a predicted cloud infrastructure state. The intelligent microservices manager invokes the deep learning model on the formed feature matrix. Operational flow continues to block 415 and returns to block 401.

At block 415, the intelligent microservices manager maps the predicted cloud infrastructure state to a scaling action(s). The intelligent microservices manager accesses the mappings, for example by querying the mappings with the state predicted by the cloud infrastructure model, and obtains an action(s) to input to an autoscaler. An autoscaler action that maps to a predicted state can specify a quantity to scale up or down of a resource for which the deep learning model and the forecasting model were trained.

At block 417, the intelligent microservices manager invokes the autoscaler with scaling action(s). The intelligent microservices manager can run the autoscaler with the action(s) that mapped to the predicted state. Automatically scaling with the autoscaler is optional, as represented by depiction of block 417 in a dashed line. In some implementations, the intelligent microservices manager can generate a report or present a visualization that indicates current state of the microservices or cloud infrastructure and the mapped autoscaler action(s). Upon approval, the intelligent microservices manager can run the autoscaler. As the predicted cloud state would be a vector of values, the intelligent microservices manager may also access data that maps the cloud predicted states in numerical form to human-readable text to be presented in the visualization or report.

The example operations are described with reference to a framework and an intelligent microservices manager. These names are chosen merely for ease of understanding the associated functionality to be implemented with program code and hardware. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

### Variations

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 405, 407, and 409 can be performed in parallel or in a different order than illustrated. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a "circuit," "module" or "system." The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, which employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine- readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

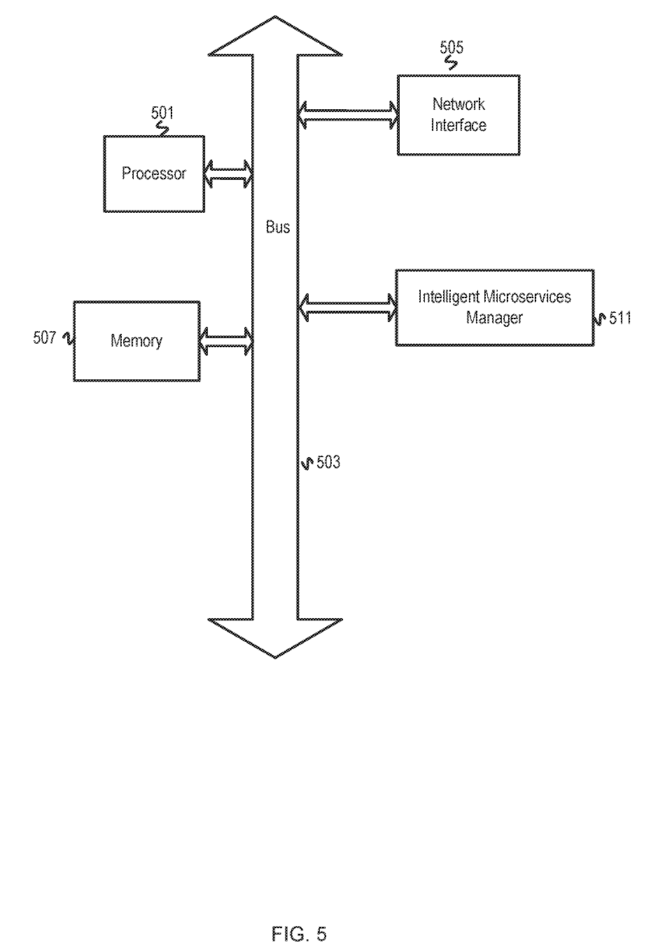

FIG. 5 depicts an example computer system with an intelligent microservices manager. The computer system includes a processor 501 (possibly including multiple processors, multiple cores, multiple nodes, and/or implementing multi- threading, etc.). The computer system includes memory 507. The memory 507 may be system memory or any one or more of the above already described possible realizations of machine-readable media. The computer system also includes a bus 503 and a network interface 505. The system also includes an intelligent microservices manager 511 that is based on the disclosed framework. The framework includes the machine learning components that have been trained while the intelligent microservices manager 511 is the program code or service that uses the framework to manage microservices of an application(s). The intelligent microservices manager 511 uses an embedding model to generate and store an embedding for each current observation of request traffic data that is obtained and then associated with embeddings for lagging observations to form a subsequence of observations. The intelligent microservices manager 511 then uses a trained forecasting model and a trained traffic profiler on the subsequence of embeddings to obtain a forecasted resource demand and an observed traffic profile. The intelligent microservices manager 511 also retrieves an expected/forecasted traffic profile for a repeating time segment that corresponds to the subsequence of observations and an observation of resource demand that corresponds to the time interval of the subsequence of embeddings. The intelligent microservices manager 511 inputs the obtained traffic profiles and forecasted and observed resource demands into the trained cloud infrastructure state predictor. The cloud infrastructure state predicted by the predictor is mapped to one or more actions of an autoscaler. This can be presented for review and approval or the autoscaler can automatically be run with the mapped action(s). Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### Terminology

Use of the phrase "at least one of' preceding a list with the conjunction "and" should not be treated as an exclusive list and should not be construed as a list of categories with one item from each category, unless specifically stated otherwise. A clause that recites "at least one of A, B, and C" can be infringed with only one of the listed items, multiple of the listed items, and one or more of the items in the list and another item not listed.

1. A method comprising:
classifying to a first of a plurality of traffic profiles, with a first model, a first
sequence of embeddings that represent multivariate request traffic behavior across distributed microservices of an application or workflow, wherein the first sequence of embeddings comprises embeddings corresponding to a current observation and lagging observations of request traffic data; forecasting a resource demand based on the first sequence of embeddings; determining an expected traffic profile of the plurality of traffic profiles based on a time of the current observation;
predicting with a second model a state of cloud infrastructure of the distributed
microservices based on the first traffic profile, the forecasted resource demand, the expected traffic profile, and current observation of resource demand; and determining an autoscaler input based on the predicted state from the second
model.

2. The method of claim 1, wherein forecasting the resource demand comprises invoking a trained forecast model on the first subsequence of embeddings, wherein
the trained forecasting model has been trained to one-step forecast resource demand based on historical subsequences of embeddings of historical observations of request traffic data.

3. The method of claim 1, wherein classifying the first subsequence of embeddings comprises invoking a trained machine learning model on the first subsequence of embeddings, wherein the trained machine learning model has been trained to group embeddings of time-series of observations of request traffic data based on similarity, wherein an observation of request traffic data comprises values for multiple features
of request traffic data.

4. The method of claim 3, wherein classifying the first subsequence of embeddings comprises determining, with the first model, a cluster membership of the first
subsequence of embeddings or k nearest neighbors of the first subsequence of embeddings.

5. The method of claim 1, wherein determining the expected traffic profile comprises querying traffic profile forecasts generated for repeating time segments from the first model, wherein the querying indicates the time of the current observation or a time window that includes the time of the current observation.

6. The method of claim 1 further comprising invoking an autoscaler with the determined autoscaler input to scale resources of the cloud infrastructure for the
predicted state of the cloud infrastructure.

7. The method of claim 1 further comprising generating a report that indicates the determined autoscaler input, the first traffic profile, the expected traffic profile, the forecasted resource demand, and the current observation of resource demand.

8. The method of claim 7, wherein generating the report comprises generating a graph of the first traffic profile, the expected traffic profile, the forecasted resource
demand, and the current observation of resource demand.

9. The method of claim 1, wherein the first model is a trained classifier and the second model is a deep learning based model.

10. A non-transitory, machine-readable medium having program code stored thereon,
the program code comprising instructions to:
train a first model to learn resource demands for traffic profiles at different time
intervals over a historical time window based on time-series request traffic data in the historical time window, wherein the traffic profiles comprise multi-dimensional representations of request traffic across distributed microservices;
generate a plurality of forecasts of resource demand for the traffic profiles at
different time intervals based on the time-series request traffic data and
corresponding time-series resource demand data;
train a second model to learn to predict a cloud infrastructure state based on a first
traffic profile indicated by the first model based on current observations of
request traffic across the distributed microservices, a forecasted resource
demand for the first traffic profile, and a second traffic profile determined from a current resource demand; and
create a forecasting pipeline that comprises the trained first model, the plurality of
forecasts of resource demand, the trained second model, and mapping
logic that maps predictions from the trained second model to cloud
autoscaler inputs.

11. The non-transitory, machine-readable medium of claim 10, wherein the instructions to train the first model comprise instructions to train the first model to
learn clusters or neighborhoods of traffic profiles for a plurality of time intervals with the time-series request traffic data grouped into subsequences corresponding to the plurality of time intervals.

12. The non-transitory, machine-readable medium of claim 10, wherein each of the different time intervals have a width w and a repeating time parameter.

13. The non-transitory, machine-readable medium of claim 12, wherein the repeating time parameter at least comprises day of week.

14. The non-transitory, machine-readable medium of claim 10, wherein the instructions to generate a plurality of forecasts of resource demand for the traffic profiles at different time intervals based on the time-series request traffic data and corresponding time-series resource demand comprise instructions to correlate observations in the time-series resource demand data with learned traffic profiles based on corresponding times.

15. An apparatus comprising:
a processor; and
a machine-readable medium having stored thereon instructions executable by the
processor to cause the apparatus to,
classify with a first model a first state of traffic across distributed microservices of
an application or workflow to a first of a plurality of traffic profiles, wherein the plurality of traffic profiles correspond to a current time interval and the first state of traffic comprises a current observation and lagging observations;
determine an expected resource demand based on the first traffic profile;
determine an expected traffic profile based on a current resource demand;
predict with a second model a state of cloud infrastructure of the distributed
microservices based on the first traffic profile, the expected resource demand, and the expected traffic profile; and
determine one of a plurality of autoscaler inputs based on the predicted state from
the second model.

16. The apparatus of claim 15, wherein the instructions to determine the expected resource demand based on the first traffic profile comprise instructions executable by the processor to cause the apparatus to map the first traffic profile to the expected resource demand at a time horizon.

17. The apparatus of claim 15, wherein the instructions to classify the first state of traffic comprise instructions executable by the processor to cause the apparatus to
generate an input feature vector with feature values extracted from a time series of the lagging observations and the current observation and to classify the input feature vector.

18. The apparatus of claim 17, wherein the instructions to classify the input feature vector comprise instructions executable by the processor to cause the apparatus to determine a cluster membership of the input feature vector or to determine k nearest neighbors of the input feature vector.

19. The apparatus of claim 15, wherein the instructions to determine the expected traffic profile based on the current resource demand comprise instructions executable by the processor to cause the apparatus to map the current resource demand and the current time interval to the expected traffic profile with a set of forecasts that map expected resource demands at different time intervals to different traffic profiles.

20. The apparatus of claim 15, wherein the machine-readable medium further comprises instructions to invoke the autoscaler with the determined autoscaler input to scale resources of the cloud infrastructure for the predicted state of the cloud infrastructure.
